(19) United States
(12) Patent Application Publication
(10) Pub. No.: US 2022/0146654 A1
(43) Pub. Date: May 12, 2022

(54) POSITION DETECTION SYSTEM AND POSITION DETECTION METHOD

(71) Applicant: KABUSHIKI KAISHA TOKAI RIKA DENKI SEISAKUSHO, Aichi (JP)

(72) Inventors: Kenichi KOGA, Aichi (JP); Satoshi MORI, Aichi (JP); Tetsuya KOBAYASHI, Toyota-shi (JP); Takahiro SHIMIZU, Toyota-shi (JP)

(73) Assignee: KABUSHIKI KAISHA TOKAI RIKA DENKI SEISAKUSHO, Aichi (JP)

(21) Appl. No.: 17/434,236

(22) PCT Filed: Feb. 28, 2020
(86) PCT No.: PCT/JP2020/008315

§ 371 Date: Aug. 26, 2021

(30) Foreign Application Priority Data
Mar. 12, 2019 (JP) 2019-044817

(51) Int. Cl. G01S 11/02

(52) U.S. Cl. CPC G01S 11/02; B60R 25/245

(57) ABSTRACT

A position detection system includes a measurement unit that obtains a measurement value related to transmission and reception of radio waves from when the radio waves are transmitted from one of first and second communication devices to the other one of the first and second communication devices to when the one of the first and second communication devices receives a response to the radio waves to detect a positional relationship of the first and second communication devices. The measurement unit obtains the measurement value related to the transmission and reception of radio waves during each of first communication in which the first communication device transmits radio waves to the second communication device and receives a response to the radio waves and second communication in which the second communication device transmits radio waves to the first communication device and receives a response to the radio waves.

### TECHNICAL FIELD

The present invention relates to a position detection system that detects the positional relationship of a first communication device and a second communication device and a position detection method.

### BACKGROUND ART

A known position detection system measures the distance between a terminal and an operated subject through the communication of radio waves between the terminal and the operated subject and determines whether the measured distance is proper (refer to, for example, Patent Document 1). The position detection system, for example, obtains a measurement value corresponding to the distance between the terminal and the operated subject. When determining that the measured value is less than a threshold value, the position detection system, for example, allows ID verification, which is performed through wireless communication between the terminal and the operated subject, to be accomplished. Thus, even when a relay or the like that is located remote from the operated subject is used to establish unauthorized communication and connect to the terminal, such communication will be detected, and unauthorized ID will not be verified.

### PRIOR ART DOCUMENTS

### Patent Document

Patent Document 1: Japanese Laid-Open Patent Publication No. 2014-227647

### SUMMARY OF THE INVENTION

### Problems that the Invention is to Solve

With such type of position detection system, there is a need to further improve the accuracy for detecting unauthorized communication.

It is an objective of the present invention to provide a position detection system and a position detection method that improve the accuracy for detecting unauthorized communication.

### Means for Solving the Problems

A position detection system in one embodiment includes a measurement unit that obtains a measurement value related to transmission and reception of radio waves from when the radio waves are transmitted from one of a first communication device and a second communication device to the other one of the first communication device and the second communication device to when the one of the first communication device and the second communication device receives a response to the radio waves to detect a positional relationship of the first communication device and the second communication device. The measurement unit obtains the measurement value related to the transmission and reception of radio waves during each of first communication in which the first communication device transmits radio waves to the second communication device and receives a response to the radio waves and second communication in which the second communication device transmits radio waves to the first communication device and receives a response to the radio waves.

A method for detecting a position, the method including obtaining, with a measurement unit, a measurement value related to transmission and reception of radio waves from when one of a first communication device and a second communication device transmits radio waves to the other one of the first communication device and the second communication device to when the one of the first communication device and the second communication device receives a response to the radio waves to detect a positional relationship of the first communication device and the second communication device. The measurement value related to the transmission and reception of radio waves is obtained with the measurement unit during each of first communication in which the first communication device transmits radio waves to the second communication device and receives a response to the radio waves and second communication in which the second communication device transmits radio waves to the first communication device and receives a response to the radio waves.

### BRIEF DESCRIPTION OF THE DRAWINGS

FIG. 1 is a diagram illustrating a position detection system in a first embodiment.

FIG. 2 is a communication sequence diagram of first communication.

FIG. 3 is a communication sequence diagram when a second communication device has a clock error.

FIG. 4 is a communication sequence diagram of second communication.

FIG. 5 is a communication sequence diagram of unauthorized communication using a relay.

FIG. 6 is a diagram illustrating determination of a positional relationship in a second embodiment.

FIG. 7 is a diagram illustrating a position detection system in a third embodiment.

FIG. 8 is a communication sequence diagram of first communication.

FIG. 9 is a communication sequence diagram of second communication.

FIG. 10 is a communication sequence diagram in a modification.

### MODES FOR CARRYING OUT THE INVENTION

### First Embodiment

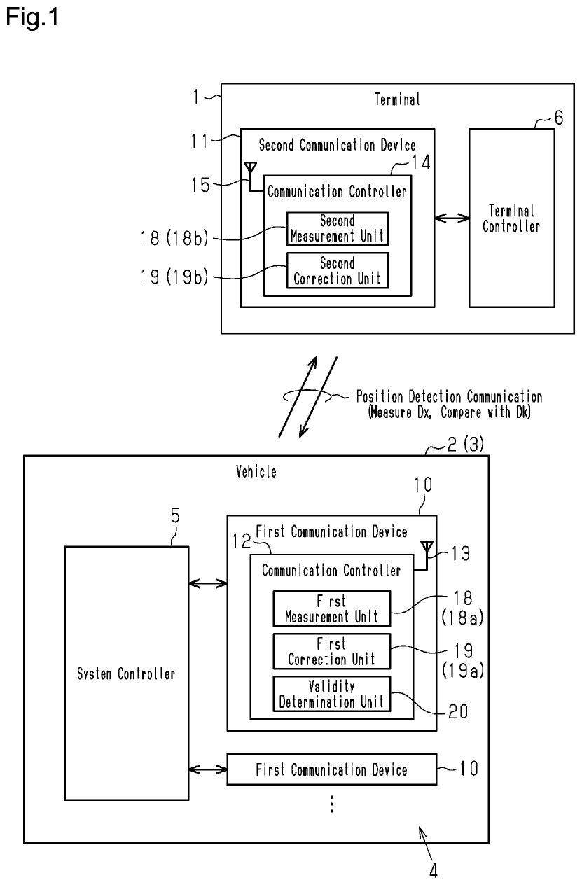

A position detection system and a position detection method according to a first embodiment will now be described with reference to FIGS. 1 to 5.

As shown in FIG. 1, a vehicle 3 serving as an operated subject 2 for a terminal 1 includes a position detection system 4 that detects the positional relationship of the vehicle 3 and the terminal 1 through communication with the terminal 1. The position detection system 4 of the present example measures the distance between the vehicle 3 and the terminal 1 through position detection communication between the vehicle 3 and the terminal 1 and determines the positional relationship of the two based on a measurement value Dx. The position detection system 4 is installed in the vehicle 3 so as to prevent unauthorized communication in which a relay or the like is used to connect the terminal 1 that is located at a position remote from the vehicle 3 to the vehicle 3 in an unauthorized manner.

The vehicle 3 includes a system controller 5 that manages the operation of the vehicle 3. The system controller 5 includes various types of devices such as a CPU, a ROM, a RAM, and the like. The system controller 5 may control the operation of the position detection system 4. The system controller 5 of the present example may also control, for example, the operation of an electronic key system of the vehicle 3. The electronic key system permits or executes the actions of an onboard door locking device and an engine device when key ID verification is accomplished through wireless communication between, for example, an electronic key serving as the terminal 1 and the vehicle 3.

The terminal 1 includes a terminal controller 6 that controls the operation of the terminal 1. In a case where the terminal 1 is an electronic key, the terminal controller 6 executes ID verification in which a key ID registered in its memory is authenticated through wireless communication with the system controller 5.

The position detection system 4 includes a first communication device 10 that executes position detection actions in the vehicle 3 and a second communication device 11 that executes position detection actions in the terminal 1. Multiple first communication devices 10 are arranged in the vehicle 3 to establish position detection communication regardless of where the second communication device 11 of the terminal 1 is positioned in the vehicle 3. The first communication device 10 and the second communication device 11 transmit and receive radio waves in, for example, the ultra-wideband (UWB) to measure the distance between the two devices. In the present example, the first communication device 10 serves as an anchor that is a primary device for the position detection communication, and the second communication device 11 serves as a tag that is a subordinate device in the position detection communication. Radio waves in the UWB are used in distance measurement communication to measure the distance between the first communication device 10 and the second communication device 11 with high resolution.

Each first communication device 10 includes a communication controller 12 that controls distance measurement communication actions and an antenna 13 that transmits and receives UWB radio waves. The communication controller 12 stores a unique first communication device ID (not shown) in a memory or the like as ID information unique to the first communication device 10. The first communication device 10 is, for example, wire-connected to the system controller 5.

The second communication device 11 includes a communication controller 14 that controls of distance measurement communication actions and an antenna 15 that transmits and receives UWB radio waves. The communication controller 14 stores a unique second communication device ID (not shown) in a memory or the like as ID information unique to the second communication device 11. The second communication device 11 is connected to the terminal controller 6 and controlled by the terminal controller 6.

The position detection system 4 includes a measurement unit 18 that obtains a measurement value Dx in accordance with the positional relationship of the first communication device 10 and the second communication device 11. The measurement unit 18 of the present example includes a first measurement unit 18a that is arranged in the communication controller 12 of each first communication device 10 and a second measurement unit 18b that is arranged in the communication controller 14 of the second communication device 11. The measurement unit 18 obtains a measurement value Dx related to transmission and reception of radio waves from when UWB radio waves for distance measurement are transmitted from one of the first communication device 10 and the second communication device 11 to the other one of the first communication device 10 and the second communication device 11 to when the one of the first communication device 10 and the second communication device 11 receives a response to the radio waves to detect a positional relationship of the first communication device 10 and the second communication device 11. The measurement unit 18 of the present example obtains a measurement value Dx related to the transmission and reception of radio waves during each of communication (hereafter referred to as first communication) in which the first communication device 10 transmits radio waves for distance measurement to the second communication device 11 and receives a response to the radio waves and communication (hereafter referred to as second communication) in which the second communication device 11 transmits radio waves for distance measurement to the first communication device 10 and receives a response to the radio waves.

The position detection system 4 includes a correction unit 19 that corrects the measurement value Dx obtained by the measurement unit 18. The correction unit 19 of the present example includes a first correction unit 19a that is arranged in the communication controller 12 of the first communication device 10 and a second correction unit 19b that is arranged in the communication controller 14 of the second communication device 11. The correction unit 19 of the present example obtains a deviation amount ΔK between the radio waves transmitted from one of the first communication device 10 and the second communication device 11 and ideal radio waves that are to be transmitted. The deviation amount ΔK is caused by a clock error in at least one of the first communication device 10 and the second communication device 11. The deviation amount ΔK may be, for example, a frequency error Δf in the transmitted UWB radio waves. The ideal radio waves may be radio waves that are transmitted when there is no clock error. The correction unit 19 corrects a measurement value Dx based on the deviation amount ΔK.

The position detection system 4 includes a validity determination unit 20 that determines the validity of the positional relationship of the first communication device 10 and the second communication device 11 based on the measurement value Dx. The validity determination unit 20 is arranged in the communication controller 12 of the first communication device 10. The validity determination unit 20 of the present example determines the validity of the positional relationship of the first communication device 10 and the second communication device 11 based on the measurement value Dx that is corrected by the correction unit 19. The validity determination unit 20 compares the measurement value Dx with a threshold value Dk to determine positional relationship validity. The validity determination unit 20 determines that the positional relationship is valid when the measurement value Dx is less than the threshold value Dk and that the positional relationship is invalid when the measurement value Dx is greater than or equal to the threshold value Dk. Each of the first communication devices 10 and the second communication device 11 executes the series of processes for the position detection communication and the positional relationship determination described above.

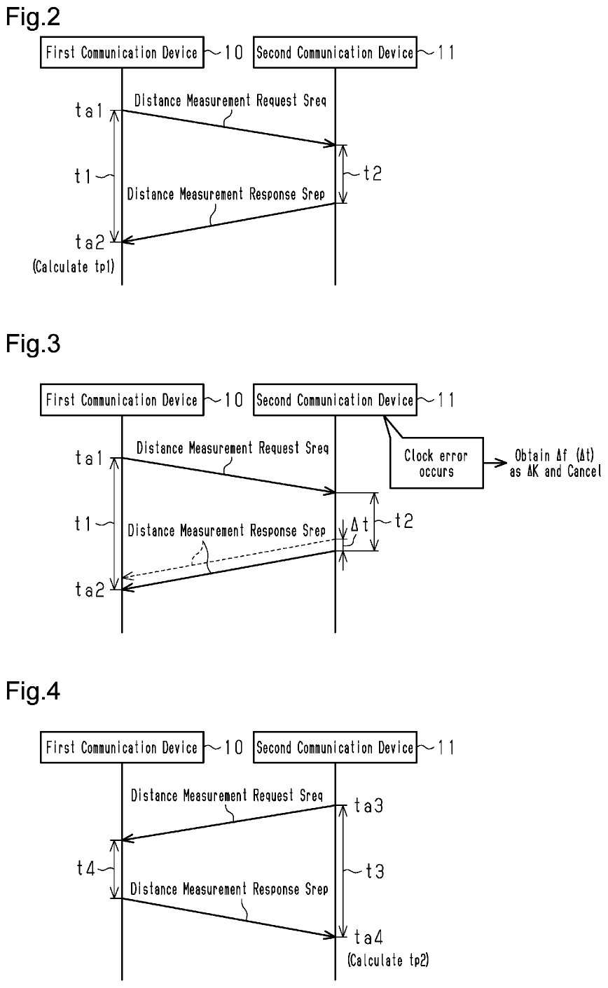

The operation and advantages of the position detection system 4 in the present embodiment will now be described with reference to FIGS. 2 to 5.

As shown in FIG. 2, the first measurement unit 18a of the first communication device 10 functions as the primary device and starts first communication for distance measurement by transmitting a distance measurement request Sreq from the antenna 13 as UWB radio waves that starts distance measurement communication. The distance measurement request Sreq may be, for example, UWB radio waves including an instruction to start distance measurement. The first measurement unit 18a uses, for example, a timer or the like of a CPU arranged in the communication controller 12 to store a transmission time ta1, which indicates the time when the distance measurement request Sreq was transmitted.

When the second measurement unit 18b of the second communication device 11 receives, with the antenna 15, the distance measurement request Sreq transmitted from the first communication device 10, the second measurement unit 18b transmits a distance measurement response Srep from the antenna 15 on UWB radio waves in response to the distance measurement request Sreq. The distance measurement response Srep may be radio waves including, for example, information indicating that the distance measurement request Sreq was correctly received. The second measurement unit 18b transmits the distance measurement response Srep to the first communication device 10 after the time used to process a response (hereafter referred to as response processing time t2) elapses from when the distance measurement request Sreq was received. The response processing time t2 is set to a fixed time length determined in advance.

When the first measurement unit 18a receives, with the antenna 13, the distance measurement response Srep transmitted from the second communication device 11, the first measurement unit 18a uses, for example, a timer or the like of a CPU arranged in the first communication device 10 to check a reception time ta2, which indicates the time at which the distance measurement response Srep was received. The first measurement unit 18a recognizes the response processing time t2 in advance. Thus, the first measurement unit 18a calculates t1, which is the time elapsed from the transmission time ta1 to the reception time ta2, and uses the response processing time t2, which is recognized in advance, to calculate tp1, which indicates a propagation time of UWB radio waves, as a measurement value Dx (for example, first measurement value). In the present example, the propagation time tp1 is calculated by subtracting t2 from t1 (tp1=t1−t2).

As shown in FIG. 3, the response processing time t2 may be shortened by an error time Δt from the value set in advance due to, for example, a clock error in the CPU of the second communication device 11. In this case, the elapsed time t1 is also shortened by the error time Δt. Thus, the propagation time tp1, which is calculated by the first measurement unit 18a using the response processing time t2, which is recognized in advance, is expressed as (t1−Δt)−t2=tp1−Δt, and the calculated propagation time tp1 is shortened from the proper value by the error time Δt. This may hinder the detection of unauthorized communication when a relay is used.

In this respect, the first correction unit 19a corrects the propagation time tp1. In the present example, the first correction unit 19a obtains a difference in frequency between the distance measurement response Srep that is received from the second communication device 11 and the ideal radio waves of the distance measurement response Srep that is recognized in advance. The first correction unit 19a measures the difference, that is, a frequency error Δf as the deviation amount ΔK.

The frequency of the distance measurement response Srep can be represented by f. In this case, f+×f and t2−Δt are inversely proportional. Thus, the first correction unit 19a obtains the error time Δt by measuring the frequency error Δf and corrects the propagation time tp1 using the frequency error Δf. This obtains an accurate propagation time tp1 that is not affected by the clock error in the second communication device 11.

Then, as shown in FIG. 4, the second measurement unit 18b of the second communication device 11 functions as the primary device and starts second communication for distance measurement by transmitting a distance measurement request Sreq from the antenna 15 as UWB radio waves that starts distance measurement communication. The distance measurement request Sreq is similar to that transmitted in the first communication. The second measurement unit 18b uses, for example, a timer or the like of the CPU arranged in the second communication device 11 to store a transmission time ta3, which indicates the time when the distance measurement request Sreq was transmitted.

When the first measurement unit 18a of the first communication device 10 receives, with the antenna 13, the distance measurement request Sreq from the second communication device 11, the first measurement unit 18a transmits a distance measurement response Srep from the antenna 13 on UWB radio waves in response to the distance measurement request Sreq. The distance measurement response Srep is similar to that transmitted in the first communication. The first measurement unit 18a transmits the distance measurement response Srep to the second communication device 11 after the time used to process a response (hereafter referred to as response processing time t4) elapses from when the distance measurement request Sreq was received.

When the second measurement unit 18b receives, with the antenna 15, the distance measurement response Srep transmitted from the first communication device 10, the second measurement unit 18b uses, for example, a timer or the like of the CPU arranged in the second communication device 11 to check a reception time ta4, which indicates the time at which the distance measurement response Srep was received. The second measurement unit 18b recognizes the response processing time t4 in advance. Thus, the second measurement unit 18b calculates t3, which is the time elapsed from the transmission time ta3 to the reception time ta4, and uses the response processing time t4, which is recognized in advance, to calculate tp2, which indicates a propagation time of UWB radio waves, as a measurement value Dx (for example, second measurement value). In the present example, the propagation time tp2 is calculated by subtracting t4 from t3 (tp2=t3−t4).

The response processing time t4 may be shortened by an error time Δt from the value set in advance due to, for example, a clock error in the CPU of the first communication device 10. In this case, the elapsed time t3 is also shortened by the error time Δt. Thus, the propagation time tp2, which is calculated by the second measurement unit 18b using the response processing time t4, which is recognized in advance, is expressed as (t3−Δt)−t4=tp2−Δt, and the calculated propagation time tp2 is shortened from the proper value by the error time Δt. This may hinder the detection of unauthorized communication when a relay is used.

In this respect, the second correction unit 19b corrects the propagation time tp2. In the present example, the second correction unit 19b obtains a difference in frequency between the distance measurement response Srep that is received from the first communication device 10 and the ideal radio waves of the distance measurement response Srep that is recognized in advance. The second correction unit 19b measures the difference, that is, a frequency error Δf as the deviation amount ΔK.

The frequency of the distance measurement response Srep can be represented by f. In this case, f+Δf and t4−Δt are inversely proportional. Thus, the second correction unit 19b obtains the error time Δt by measuring the frequency error Δf and corrects the propagation time tp2 using the frequency error Δf. This obtains an accurate propagation time tp2 that is not affected by the clock error in the first communication device 10.

Information on the propagation time tp2, that is, a value of the propagation time tp2 is transmitted through wireless communication from the second communication device 11 to the first communication device 10. The value of the propagation time tp2 may be transmitted, for example, over a UWB communication network for distance measurement. Alternatively, the value of the propagation time tp2 may be transmitted over a communication network that does not use UWB communication, for example, a communication network of the electronic key system including the vehicle 3 and the terminal 1.

The validity determination unit 20 determines the validity of communication based on the propagation times tp1, tp2 that are measurement values Dx corrected by the correction unit 19. In this case, the validity determination unit 20 compares the propagation times tp1, tp2 with the threshold value Dk. The validity determination unit 20 determines that the positional relationship of the first communication device 10 and the second communication device 11 is invalid when at least one of the propagation times tp1, tp2 is greater than or equal to the threshold value Dk. Thus, even when a relay or the like is used to perform communication in an unauthorized manner, the communication will be determined as being unauthorized. Thus, communication will not be established.

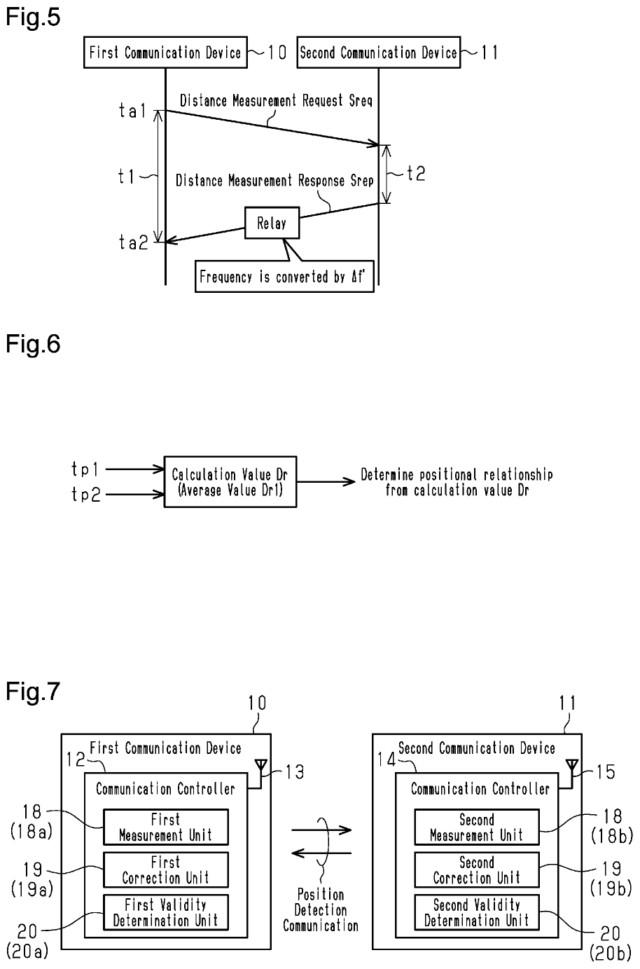

As shown in FIG. 5, when a relay is used to perform unauthorized communication in the first communication, the frequency of the distance measurement response Srep may be changed by an amount corresponding to a conversion value Δf′ to slightly lower the frequency to f+Δf−Δf′. In this case, the first communication device 10 will acknowledge the response processing time t2 as being a relatively long value of t2−Δt+Δt′. Thus, a short measured propagation time tp1 will be calculated, and unauthorized communication using the relay may be established.

When the distance measurement response Srep transmitted from the second communication device 11 to the first communication device 10 is frequency-converted during unauthorized communication, frequency conversion is performed in the first communication but not in the second communication. Thus, the propagation time tp1 measured in the first communication will not match the propagation time tp2 measured in the second communication. Accordingly, the consistency of the propagation times tp1, tp2 can be checked to counter an attack that frequency-converts the distance measurement response Srep transmitted from the second communication device 11 to the first communication device 10.

The validity determination unit 20 determines that the positional relationship of the first communication device 10 and the second communication device 11 is valid when the propagation times tp1, tp2 match or are values approximate to each other as long as the propagation times tp1, tp2 are both less than the threshold value Dk. Thus, when, for example, ID verification executed through wireless communication with the terminal 1, which serves as an electronic key, is accomplished between the vehicle 3 and the terminal 1, the ID will be verified. Thus, the locking and unlocking of a vehicle door of the vehicle 3 will be performed or permitted. Alternatively, the starting of the engine of the vehicle 3 will be permitted.

The validity determination unit 20 determines that the positional relationship of the first communication device 10 and the second communication device 11 is invalid when the propagation times tp1, tp2 do not match or are not values approximate to each other irrespective of the comparison result of the propagation times tp1, tp2 with the threshold value Dk. Thus, when undergoing an attack that frequency-converts the distance measurement response Srep transmitted from the second communication device 11 to the first communication device 10, the communication will be determined as being unauthorized. In this case, communication will not be established. This improves the security of position detection communication.

The first embodiment has the following advantages.

Measurement values Dx are obtained in the first communication and the second communication to determine unauthorized communication in the two communication paths. This improves the detection accuracy of unauthorized communication.

The first measurement unit 18a and the second measurement unit 18b measure propagation times tp1, tp2 of radio waves that are different measurement values Dx. Thus, the positional relationship is accurately detected from the propagation times tp1, tp2 of radio waves measured during communication between the first communication device 10 and the second communication device 11.

The position detection system 4 includes the correction unit 19 and obtains a frequency error Δf as a deviation amount ΔK, which is caused by a clock error in the first communication device 10 and the second communication device 11. The correction unit 19 corrects a measurement value Dx based on the frequency error Δf. The optimized measurement value Dx is further advantageous for improving accuracy when determining the positional relationship.

The position detection system 4 includes the validity determination unit 20 that determines the validity of the positional relationship of the first communication device 10 and the second communication device 11 based on a measurement value Dx that is corrected by the correction unit 19. The determination of the validity of the positional relationship based on the corrected measurement value Dx allows for accurate determination of the positional relationship validity.

### Second Embodiment

A second embodiment will now be described with reference to FIG. 6. The second embodiment differs from the first embodiment in how the positional relationship is determined. Thus, the same reference numerals are given to those components that are the same as the corresponding components of the first embodiment. Such components will now be described in detail, and the description will focus on the differences.

As shown in FIG. 6, the validity determination unit 20 obtains a calculation value Dr based on a measurement value Dx measured in the first communication and a measurement value Dx measured in the second communication and determines the validity of a positional relationship from the calculation value Dr. In the present example, the calculation value Dr can be expressed as an average value Dr1 (=(tp1+tp2)/2) of a propagation time tp1 measured in the first communication and a propagation time tp2 measured in the second communication.

In the present example, the validity determination unit 20 obtains the propagation times tp1, tp2 and calculates the average value Dr1. The validity determination unit 20 compares the average value Dr1 with a predetermined threshold value Dk to determine the validity of the positional relationship of the first communication device 10 and the second communication device 11. In this case, the validity determination unit 20 determines that the positional relationship is valid when the average value Dr1 is less than the threshold value Dk, and the validity determination unit 20 determines that the positional relationship is invalid when the average value Dr1 is greater than or equal to the threshold value Dk. Preferably, the threshold value Dk of the present example is compared with the average value of the propagation times tp1, tp2 and thus set to a value that differs from that of the first embodiment.

In addition to the advantages of the first embodiment, the second embodiment has the following advantages.

The validity determination unit 20 obtains the average value Dr1 of the propagation time tp1 measured in the first communication and the propagation time tp2 measured in the second communication to determine the validity of the positional relationship from the average value Dr1. Thus, even when unauthorized communication in which a frequency is converted is performed in one of the first communication and the second communication, unauthorized communication is detected by determining the validity of the communication from the average value Dr1. This is further advantageous for improving accuracy when determining the positional relationship validity.

### Third Embodiment

A third embodiment will now be described with reference to FIGS. 7 to 9. The description will focus on differences from the first embodiment.

As shown in FIG. 7, the validity determination unit 20 of the present example includes a first validity determination unit 20a that is arranged in the communication controller 12 of the first communication device 10 and a second validity determination unit 20b that is arranged in the communication controller 14 of the second communication device 11.

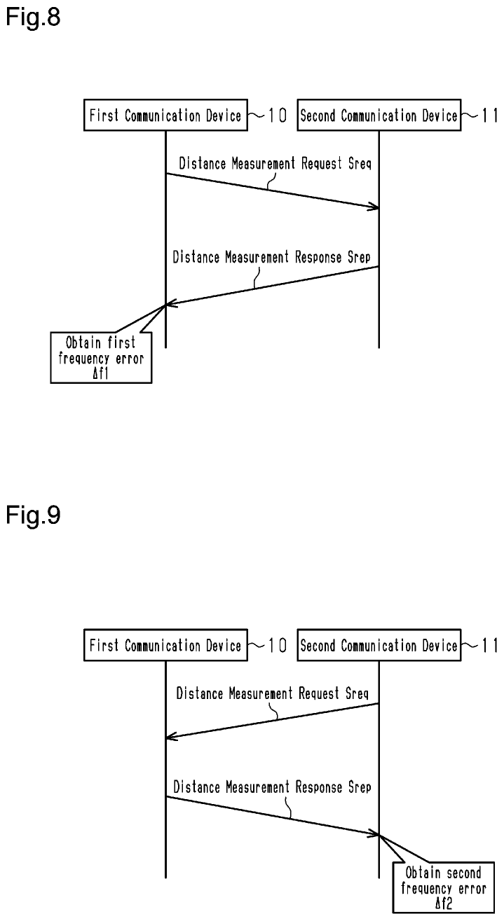

As shown in FIG. 8, the first validity determination unit 20a obtains a frequency error Δf (hereafter referred to as first frequency error Δf1) of radio waves in the first communication transmitted from the first communication device 10 to the second communication device 11 and then back to the first communication device 10. The first frequency error Δf1 is calculated by the first correction unit 19a of the first communication device 10. In the present example, the first correction unit 19a calculates the first frequency error Δf1 of radio waves in the first communication by obtaining the difference between a frequency recognized in advance and a measured frequency for a distance measurement response Srep transmitted from the second communication device 11 to the first communication device 10.

Then, as shown in FIG. 9, the second validity determination unit 20b obtains a frequency error Δf (hereafter referred to as second frequency error Δf2) of radio waves in the second communication transmitted from the second communication device 11 to the first communication device 10 and then back to the second communication device 11. The second frequency error Δf2 is calculated by the second correction unit 19b of the second communication device 11. In the present example, the second correction unit 19b calculates the second frequency error Δf2 of radio waves in the second communication by obtaining the difference between a frequency recognized in advance and a measured frequency for a distance measurement response Srep transmitted from the first communication device 10 to the second communication device 11.

When, for example, a distance measurement response Srep is returned to a communication counterpart during both of the first communication and the second communication, the distance measurement response Srep may be frequency-converted to a lower frequency by a relay or the like. In this case, the propagation time tp1 obtained in the first communication will match the propagation time tp2 obtained in the second communication. This may hinder the detection of unauthorized communication.

Thus, the validity determination unit 20 of the present example determines the validity of the positional relationship of the first communication device 10 and the second communication device 11 from the consistency of the first frequency error Δf1 in the first communication and the second frequency error Δf2 in the second communication. That is, the validity determination unit 20 determines the validity of the positional relationship by checking the consistency of which one of the radio waves transmitted from the first communication device 10 and the radio waves transmitted from the second communication device 11 have a higher or lower frequency.

When a distance measurement response Srep in, for example, the first communication is converted to a lower frequency by a relay or the like, the first validity determination unit 20a recognizes that the frequency of radio waves transmitted by the second communication device 11 is lower by a first frequency error Δf1 than the frequency of radio waves transmitted by the first communication device 10. When a distance measurement response Srep in, for example, the second communication is converted to a lower frequency by a relay or the like, the second validity determination unit 20b recognizes that the frequency of radio waves transmitted by the first communication device 10 is lower by a second frequency error Δf2 than the frequency of radio waves transmitted by the second communication device 11.

In addition to the advantages of the first embodiment, the third embodiment has the following advantages.

The first communication device 10 and the second communication device 11 both recognize that the frequency of the radio waves that it transmitted is lower than the frequency of the radio waves transmitted by the counterpart device. This results in inconsistent recognition. Accordingly, when the validity determination unit 20 recognizes inconsistency in the frequency errors Δf, the validity determination unit 20 determines that the positional relationship of the first communication device 10 and the second communication device 11 is invalid. Thus, even when a frequency is converted in the first communication and the second communication to perform unauthorized communication, the inconsistency in frequency errors is recognized during communication to detect unauthorized communication. This is further advantageous for improving accuracy when determining the validity of the positional relationship.

The above-described embodiments may be modified as follows. The above-described embodiments and the following modifications can be combined as long as the combined modifications remain technically consistent with each other.

### Measurement Unit 18

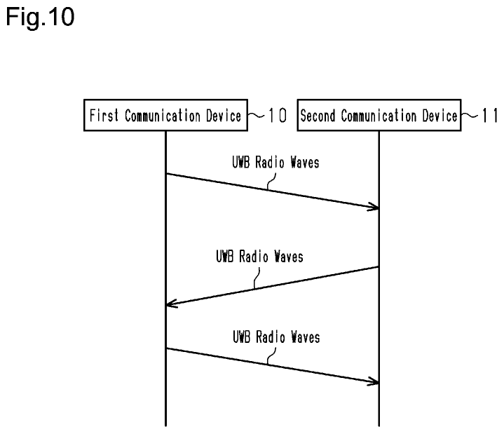

As shown in FIG. 10, the UWB radio waves may be transmitted from the first communication device 10 to the second communication device 11, then from the second communication device 11 to the first communication device 10, and then again from the first communication device 11 to the second communication device 11 to obtain a measurement value Dx from the series of transmission processes. The three-message communication is further advantageous for improving accuracy when determining the validity of a positional relationship.

In each embodiment, the measurement unit 18 does not need to be arranged in the first communication device 10 and the second communication device 11. Instead, the measurement unit 18 may be arranged, for example, in the system controller 5 and the terminal controller 6.

In each embodiment, a timer or the like does not need to be used to check the time when measuring the measurement value Dx. Instead, the measurement value Dx may be obtained from, for example, the phase of radio waves or the like.

### Measurement Value Dx

In each embodiment, a measurement value Dx is not limited to propagation times tp1, tp2. Instead, the measurement value Dx may be a received signal strength when radio waves are received.

In each embodiment, a measurement value Dx is not limited to propagation times tp1, tp2. Instead, the measurement value Dx may be a parameter that allows the positional relationship to be checked.

### First Communication Device 10

In each embodiment, the first communication device 10 may be incorporated into the system controller 5.

In each embodiment, the first communication device 10 may be retrofitted to the vehicle 3.

In each embodiment, the first communication device 10 does not need to be arranged in vehicle 3. Instead, the first communication device 10 may be installed in various types of devices or machines.

### Second Communication Device 11

In each embodiment, the second communication device 11 may be incorporated into the terminal controller 6 of the terminal 1.

In each embodiment, the second communication device 11 may be installed in a high-performance mobile phone in advance.

### Validity Determination Unit 20

In each embodiment, the validity determination unit 20 may be arranged in the terminal 1.

In each embodiment, the validity determination unit 20 may be arranged in the system controller 5 or the terminal controller 6.

### Correction Unit 19

In each embodiment, the correction unit 19 does not need to detect an error from a frequency deviation of radio waves. Instead, the correction unit 19 may detect an error using a parameter other than frequency.

In each embodiment, a deviation amount ΔK is not limited to a frequency error M. Instead, the deviation amount ΔK may be a different parameter.

In each embodiment, the correction unit 19 may be omitted from the position detection system 4.

### Calculation Value Dr

In the second embodiment, a calculation value Dr may be a weighted average.

In the second embodiment, a calculation value Dr is not limited to an average value Dr1. Instead, the calculation value Dr may be a total value.

In the second embodiment, a calculation value Dr may be a parameter using measurement values Dx that are obtained in the first communication and the second communication.

### Consistency of Frequency Errors

In the third embodiment, the checking of frequency error consistency includes checking whether, for example, the number of radio wave pulses per unit time is the same.

In the third embodiment, the checking of frequency error consistency includes checking whether, for example, the radio wave pulse width is the same.

### Position Detection System 4

In the first embodiment, the validity determination unit 20 may be arranged in the terminal 1 to determine the validity of a measurement value.

In each embodiment, the second communication device 11 may transmit radio waves to the first communication device 10 and execute position detection.

In each embodiment, when multiple first communication devices 10 are installed in a vehicle body, the position detection system 4 preferably communicates with each first communication device 10 and measures the distance. In this case, the position detection system 4 preferably determines whether the positional relationship is valid by checking each distance.

In each embodiment, the measurement of position does not need to be performed through UWB communication. Instead, the measurement may be performed using Bluetooth (registered trademark). In this case, the received signal strength of radio waves may be measured for each channel of radio waves transmitted in Bluetooth communication, and the positional relationship of the two devices may be determined from the received signal strengths.

In each embodiment, position detection communication does not need to be performed at a time differing from smart communication. Position detection communication may be performed at the same time as smart communication.

In each embodiment, during position detection communication, for example, one of the first communication device 10 and the second communication device 11 may solely transmit UWB radio waves to obtain a position from a propagation time of the UWB radio waves that are reflected by an object and returned to the transmitting device.

In each embodiment, to determine the positional relationship using radio waves in UWB communication, the positional relationship may be estimated from, for example, the time required to transmit and receive radio waves or from the direction in which radio waves travel. Further, to determine the positional relationship using radio waves in Bluetooth communication, the positional relationship may be estimated from, for example, the propagation characteristics of radio waves, the received signal strength of radio waves, the time required to transmit and receive radio waves, the direction in which radio waves travel, or with the use of an array antenna.

In each embodiment, a specific one of multiple first communication devices 10 may serve as a master and the other ones may serve as slaves. In this case, the first communication devices 10 that serve as the slaves may communicate with the system controller 5 via the first communication device 10 that serves as the master.

### Electronic Key System

In each embodiment, the electronic key system may be a smart verification system, a wireless key system, or an immobilizer system.

In each embodiment, the frequency of radio waves used for the electronic key system is not limited to the low frequency (LF) band or the ultra-high frequency (UHF) band. Instead, radio waves may be on other frequencies.

In each embodiment, the electronic key system may perform communication through, for example, short-range wireless communication, such as Bluetooth (registered trademark) or radio frequency identification (RFID), or communication using infrared light or the like.

In each embodiment, the electronic key system may share the position detection system 4. In this case, communication for position detection and determination are executed as the terminal 1 is verified in UWB communication.

### Others

In each embodiment, the terminal 1 is not limited to an electronic key or a high-performance mobile phone. Instead, the terminal 1 may be any type of key to the operated subject 2.

In each embodiment, the operated subject 2 is not limited to the vehicle 3. Instead, the operated subject 2 may be any of various types of devices or machines.

1. A position detection system, comprising:
a measurement unit that obtains a measurement value related to transmission and reception of radio waves from when the radio waves are transmitted from one of a first communication device and a second communication device to the other one of the first communication device and the second communication device to when the one of the first communication device and the second communication device receives a response to the radio waves to detect a positional relationship of the first communication device and the second communication device,
wherein the measurement unit obtains the measurement value related to the transmission and reception of radio waves during each of first communication in which the first communication device transmits radio waves to the second communication device and receives a response to the radio waves and second communication in which the second communication device transmits radio waves to the first communication device and receives a response to the radio waves.

2. The position detection system according to claim 1, wherein the measurement unit measures a propagation time of the radio waves as the measurement value.

3. The position detection system according to claim 1, further comprising:
a validity determination unit that determines whether the positional relationship of the first communication device and the second communication device is valid, wherein
the validity determination unit acquires, as a first measurement value, the measurement value that is obtained in the first communication,
the validity determination unit acquires, as a second measurement value, the measurement value that is obtained in the second communication,
the validity determination unit determines that the positional relationship is valid when the first measurement value and the second measurement value are consistent and the first measurement value and the second measurement value are both less than a threshold value, and
the validity determination unit determines that the positional relationship is invalid when the first measurement value and the second measurement value are inconsistent irrespective of a comparison result of the first measurement value and the second measurement value with the threshold value.

4. The position detection system according to claim 1, further comprising
a correction unit that obtains a deviation amount, which is caused by a clock error in at least one of the first communication device and the second communication device, based on radio waves transmitted from the one of the first communication device and the second communication device to the other one of the first communication device and the second communication device and ideal radio waves that are to be transmitted, wherein the correction unit corrects the measurement value, which is related to the deviation amount, based on the deviation amount.

5. The position detection system according to claim 4, further comprising:
a validity determination unit that determines whether the positional relationship of the first communication device and the second communication device is valid based on the measurement value that is corrected by the correction unit.

6. The position detection system according to claim 5, wherein the validity determination unit obtains a calculation value based on the measurement value measured in the first communication and the measurement value measured in the second communication to determine whether the positional relationship of the first communication device and the second communication device is valid from the calculation value.

7. The position detection system according to claim 5, wherein the validity determination unit determines whether the positional relationship of the first communication device and the second communication device is valid from consistency of a frequency error in the radio waves in the first communication and a frequency error in the radio waves in the second communication.

8. A method for detecting a position, the method comprising:
obtaining a measurement value related to transmission and reception of radio waves with a measurement unit from when one of a first communication device and a second communication device transmits radio waves to the other one of the first communication device and the second communication device to when the one of the first communication device and the second communication device receives a response to the radio waves to detect a positional relationship of the first communication device and the second communication device, wherein
the measurement value related to the transmission and reception of radio waves is obtained with the measurement unit during each of first communication in which the first communication device transmits radio waves to the second communication device and receives a response to the radio waves and second communication in which the second communication device transmits radio waves to the first communication device and receives a response to the radio waves.
